(19) United States
(12) Patent Application Publication
(10) Pub. No.: US 2011/0209201 A1
(43) Pub. Date: Aug. 25, 2011

(54) METHOD AND APPARATUS FOR ACCESSING MEDIA CONTENT BASED ON LOCATION

(75) Inventor: Laurent Chollat, Espoo (FI)

(73) Assignee: Nokia Corporation, Espoo (FI)

(21) Appl. No.: 12/708,745

(22) Filed: Feb. 19, 2010

(51) Int. Cl. G06F 21/00; G06F 3/048; G06F 15/16; G06T 15/00; H04B 1/38

(52) U.S. Cl. 726/4; 715/764; 709/219; 345/419; 455/566; 709/217

(57) ABSTRACT

An approach is provided for providing a method for accessing media based on physical locations. A media access platform causes, at least in part, rendering of a user interface, the user interface corresponding to a geographical area and including one or more focal areas. Next, the media access platform determines media content available within the geographical area. Then, the media access platform also causes, at least in part, rendering of one or more representations of the available media content in the user interface.

### BACKGROUND

Service providers (e.g., wireless, cellular, etc.) and device manufacturers are continually challenged to deliver value and convenience to consumers by, for example, providing compelling network services. One area of development has been services and applications related to generating and consuming media content (e.g., music, video, electronic books, files, documents, etc.). This development has resulted in an explosion of media content available to users. For example, it is not uncommon for a user of modern media services to have access to several million or more media content items at any given time. The vast extent of available media content can easily overwhelm the user, thereby making it difficult for a user to discover and locate media content of interest to the user. Moreover, media content may be available from any number of providers (e.g., content providers, distributors, advertisers, etc.) corresponding to various locations (e.g., store fronts, event venues, radio or television stations, etc.). Therefore, the service providers and device manufactures face significant technical challenges to enable users to sift through the volume of available content and discover media of potential interest that are often times associated with particular locations.

### SOME EXAMPLE EMBODIMENTS

Therefore, there is a need for an approach for discovering and accessing media based on location.

According to one embodiment, a method comprises causing, at least in part, rendering of a user interface, the user interface corresponding to a geographical area and including one or more focal areas. The method also comprises determining media content available within the geographical area. The method further comprises causing, at least in part, rendering of one or more representations of the available media content in the user interface.

According to another embodiment, an apparatus comprising at least one processor, and at least one memory including computer program code, the at least one memory and the computer program code configured to, with the at least one processor, cause, at least in part, the apparatus to render of a user interface, the user interface corresponding to a geographical area and including one or more focal areas. The apparatus also caused to determine media content available within the geographical area. The apparatus is further caused to render one or more representations of the available media content in the user interface.

According to another embodiment, a computer-readable storage medium carrying one or more sequences of one or more instructions which, when executed by one or more processors, cause, at least in part, an apparatus to render of a user interface, the user interface corresponding to a geographical area and including one or more focal areas. The apparatus also caused to determine media content available within the geographical area. The apparatus is further caused to render one or more representations of the available media content in the user interface.

According to another embodiment, an apparatus comprises means for causing, at least in part, rendering of a user interface, the user interface corresponding to a geographical area and including one or more focal areas. The apparatus also comprises means for determining media content available within the geographical area. The apparatus further comprises means for causing, at least in part, rendering of one or more representations of the available media content in the user interface.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of accessing media content based on physical locations, according to one embodiment;

FIG. 2 is a diagram of the components of a media access platform, according to one embodiment;

FIGS. 3A and 3B are flowcharts of a process for accessing media based on physical locations, according to one embodiment;

FIG. 4 is a flowchart of a process for authorizing access to media content items, according to one embodiment;

FIGS. 5A-5B are diagrams of user interfaces utilized in the processes of FIGS. 3A and 3B, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for accessing media based on physical locations are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

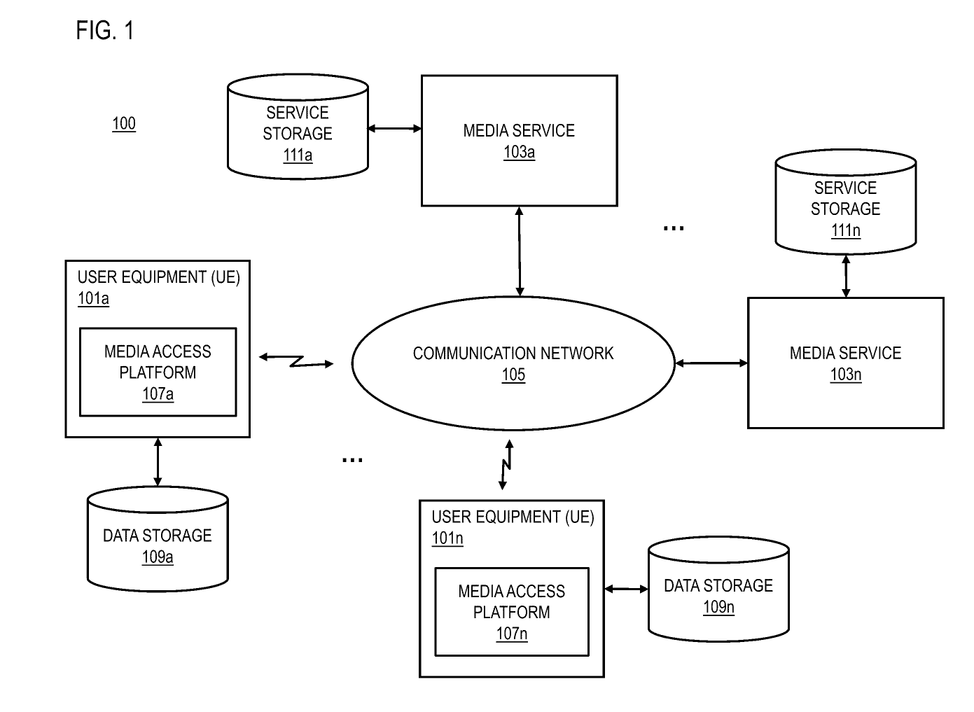

FIG. 1 is a diagram of a system capable of accessing media based on physical locations, according to one embodiment. As discussed previously, it is noted that modern media services offer a vast collection of media content over, for instance, the Internet and other sources (e.g., local access points, flash media, etc.). This vast collection can quickly overwhelm the user, thereby making it extremely difficult for the user to discover, identify, and/or access content of interest. For example, a conventional or traditional approach to discovering content is by browsing or searching websites, service directories, receiving recommendations, and the like, to find content of interest. However, it is noted that this conventional approach has been commonly and ubiquitously used in many of such media services. Accordingly, the user may find the traditional method for finding content uninteresting, and therefore, may be discouraged from using these services. Without an exciting or novel presentation, content that would otherwise appeal to the user might go unnoticed and be missed.

To address this problem, a system 100 of FIG. 1 introduces the following capabilities: (1) rendering a user interface of a user device to include a focal area in the user interface corresponding to a geographical area, (2) rendering representations of media content items available within the geographical area, (3) detecting movement of the device to bring a representation of the media content item within the focal area, and (4) accessing the media content item corresponding to the representation within the focal area. More specifically, the system 100 enables the UE 101 to find media content associated with physical locations within a certain geographical area, and to render at least a portion of the geographical area in the user interface. The system 100 also enables the UE 101 to render a user interface that corresponds to a geographical area and shows representations depicting locations of media content associated with corresponding physical locations within the geographical area. The system 100 further enables positioning of the representation within a focal area in the user interface so as to access the media content item associated with the physical location corresponding to the representation.

The source of the media content item available for user access may be the media services 103a-103n and/or another one of the UEs 101a-101n. In one embodiment, the UE 101 may access the media from the media services 103a-103n and/or another one of the UEs 101a-101n via an established connection through the communication network 105. For example, the user interface of the UE 101 may show representations depicting locations of media hotspots (e.g. WiFi hotspots sponsored by radio station). By way of example, the depiction of the locations in the user interface can comprise any form of presentation (e.g., virtual reality display, three-dimensional maps, two-dimensional maps, etc.) that represents the actual or approximate locations of the media hotspots or other media sources. It is also contemplated that the display need not render a literal map of the area, but instead can be a stylized representation of the location and the media (e.g., a radar-like display indicating the locations or approximate locations of the media as points or “blips”). The user can then position at least one of the representations for the media hotspots or media source in a designated focal area of the user interface to access media from the media hotspot. As another example, the media depicted in the user interface of the UE 101 may be an advertisement or descriptive media about a particular location. For instance, a grocery store may make media (e.g., audio and/or video) available over a media hotspot that describes ongoing special sales or discounts, or a museum may make media available to describe current exhibits. A nearby user with a UE 101 can then access this media to learn more about the location.

In one embodiment, the system 101 can perform different actions with respect to the media depending on, for instance, the length of time the user holds the representation of the media hotspot or media in the focal area of the user interface. For example, if the representation of media is in the focal area of the user interface for a short period of time, the system 100 may initiate a preview of the media. Then, if the representation of media held in the focal area for a longer period of time, the system 100 can initiate download of the media to the UE 101.

In another embodiment, the system 100 may enforce authorization features (e.g., user registration and/or password) to access available media content. More specifically, the system 100 can determine whether the user has access rights to the requested media. By way of example, these access rights may be available for purchase, subscription, etc. from the media service 103. In some cases, if the user does not have access rights, the system 100 may provide limited access to the media (e.g., offer a preview of the media or direct the user to the service 103 to obtain the rights). As one example, when the user selects one of the icons on the UE 101 representing a requested media item, a corresponding media/application store (e.g., Nokia's Ovi store) client can be opened or executed to acquire the item. On execution of the media/application store client, the user's account can be charged for the selected content. If needed, the content is also downloaded or otherwise transferred to the UE 101. Thus, to support this capability, the icons can have an interface which links the icon to the corresponding media/application store. More specifically, the media/application store receives information regarding the icon so that store can select the media represented by the icon from the store. The user can then either accept or deny the downloading of the content. In one embodiment, the media downloading is represented in the user interface to show transfer of the content from the icon to the device's memory (e.g. data storage medium 109). In addition or alternatively, the user can use drag-and-drop from the icon to the memory to initiate a request to transfer the media to the memory of the UE 101.

Therefore, the capabilities of the system 100 enable the user to rely on the UE 101 to show representations of media content items within a geographical area (e.g., nearby geographical area) that may be available for user access and to focus on the representation in order to access the media content from the source of the media for media access. An advantage of the approach described herein is that a user can easily locate media within a physical environment by intuitively pointing or otherwise directing a user interface display to the location or approximate location of the media, thereby reducing the steps for searching and retrieving such media using traditional means. Moreover, by visualizing media in such a user interface, the user gets a feeling of being immersed within the surrounding environment that is populated or “alive” with media content. In other words, as the user observes locations related to media content (e.g., a music store, an opera house or a concert hall), and becomes curious about available media content associated with such locations, the user may quickly discover and access related content and information using the user interface according to embodiments of the invention. Thus, this approach provides convenience in that the user does not personally have to go to these locations of the media content to determine whether these locations provide media access for the media associated with those locations. As a result, this approach enhances the user experience in discovering and accessing media desired by the user. Therefore, means for accessing media based on physical locations are anticipated.

As shown in FIG. 1, the system 100 comprises a user equipment (UE) 101 having connectivity to the media service 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Bluetooth® Low end, universal local storage (ULS), near field communication (NFC), Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

The UE 101 may include a media access platform 107. In one embodiment, the media access platform 107 is capable of handling various operations related to media playback and communication of media using the UE 101. For example, the media access platform 107 may manage incoming or outgoing media via the UE 101, and display such communication. More specifically, the media access platform 107 provides a user interface showing representations of media content items available for locations in the area surrounding the UE 101. The media access platform 107 may also provide, in one embodiment, media metadata including specified data to identify the content and its location data. The metadata may be provided from the media access platform 107 to the UE 101 as a file or the like. The metadata, when used, can locate the content or media item in the media access platform 107 or in a storage linked to a purchase platform (e.g., a media/application store like the Ovi store). The media access platform 107 may provide a way to focus on at least one of the representations corresponding to the content items in order to access the corresponding media. Further, the media access platform 107 may include interfaces (e.g., application programming interfaces (APIs)) that enable the user to communicate with Internet-based websites or to use various communications services (e.g., e-mail, instant messaging, text messaging, etc.) of the UE 101. In some embodiments, the media access platform 107 may include a user interface (e.g., graphical user interface, audio based user interface, etc.) to access Internet-based communication services or communication networks in order to find sources of the media and access the media from the sources.

The media service 103 may provide media content such as music, videos, television services, etc. such that the UEs 101a-101n can access the media content via the communication network 105. Thus, the media service 103 may provide media data transfer service, media stream service, radio broadcasting service and television broadcasting service, and may further provide information related to the media content. Each of the media services 103a-103n may provide different media content and different types of media services. The media service 103 may be connected to a media storage medium 113 to store or access data such as media content items. The media service 103 may also provide physical locations (e.g. coordinates) of the media content and information (e.g. artist name, genre, release date, etc.) related to the media content such that the UEs 101a-101n can access this information via the communication network 105. The media service 103 is also able to perform various computations to support the functions of the media access platform 107, some of which may be performed for the UE 101. For example, the media service 103 can estimate whether a representation of the media content item is within a focal area, and send the estimation to the UE 101. In addition, the media service 103 may provide a media purchase service that allows a user to purchase certain media content to download or to stream.

By way of example, the UE 101 and the media service 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

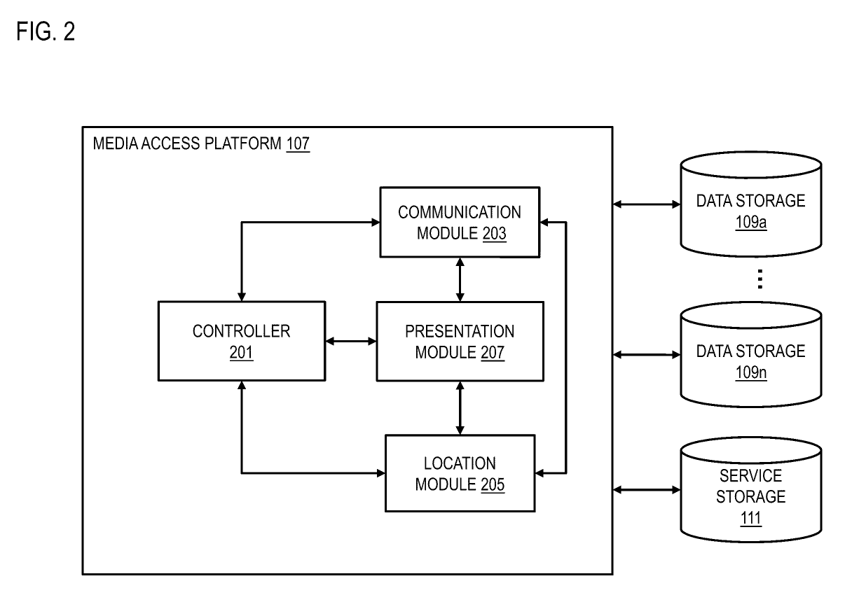

FIG. 2 is a diagram of the components of the media access platform 107, according to one embodiment. By way of example, the media access platform 107 includes one or more components for accessing media based on physical locations. It is contemplated that the functions of these components may be combined in one or more components or performed by other components of equivalent functionality. In this embodiment, the media access platform 107 includes a controller 201, a communication module 203, a location module 205, and a presentation module. The controller 201 oversees tasks, including tasks performed by the controller 201, the communication module 203, the location module 205, and the presentation module 207. The presentation module 207 controls display of a user interface such as graphical user interface, to convey information and to allow a user to interact with the UE 101 via the interface. In more detail, the presentation module 207 renders a user interface such that the user interface corresponds to a geographical area and includes a focal area within the user interface. The presentation module 207 may also render representations of available media content in the user interface that corresponds to the geographical area. The presentation module 207 also interacts with the controller 201, the communication module 203 and the location module 205 to render the user interface, and may further display an augmented reality, a virtual reality, a two dimensional mapping or a three-dimensional mapping.

The location module 205 locates sources of available media content around the UE 101, and determines and/or estimates locations of the media content items, such that the presentation module 207 can render the user interface based on the determined/estimated locations of the media content items. The location module 205 also determines whether a representation of the media content item is within a focal area of the user interface display, and further calculates the amount of time that the representation of the media is within the focal area. In one embodiment, the amount of time the representation of the media content item is held in the focal area can determine the action the taken with respect to the media content item. The location module 205 may provide information for the communication module 203 to set up communication with the source of the media (e.g., media hotspot). This communication can then support transfer of content from the media source to, for instance, the UE 101. Further, the location module 205 determines the location of the UE 101 and detects movement with respect to a location, directional heading and angle of elevation of the UE 101. In one embodiment, this information is also sent to the presentation module 207 to render the user interface according to movement of the location of the UE 101. As previously described, the communication module 203 manages communication sessions with the media source using various forms of communication. For example, the communication module can support a direct (e.g., peer to peer) short range communication links (e.g., WiFi, Bluetooth, etc.), communication over the network 105 (e.g., cellular, wireless, LAN, etc.) for transferring media and related information. In certain embodiments, the communication module 203 also provides an authentication feature to enable communication between the UE 101 and the source of the media only if there is proper authorization.205205205The UE 101 may also be connected to storage media such as the data storage media 109a-109n such that the media access platform 107 can access data or store data in the data storage media 109a-109n. If the data storage media 109a-109n are not local, then they may be accessed via the communication network 105. The UE 101 may also be connected to the media storage 113 via the communication network 105 such that the media access platform 107 may be able to control the data in the media storage medium 113 and store and access data in the media storage medium 113.

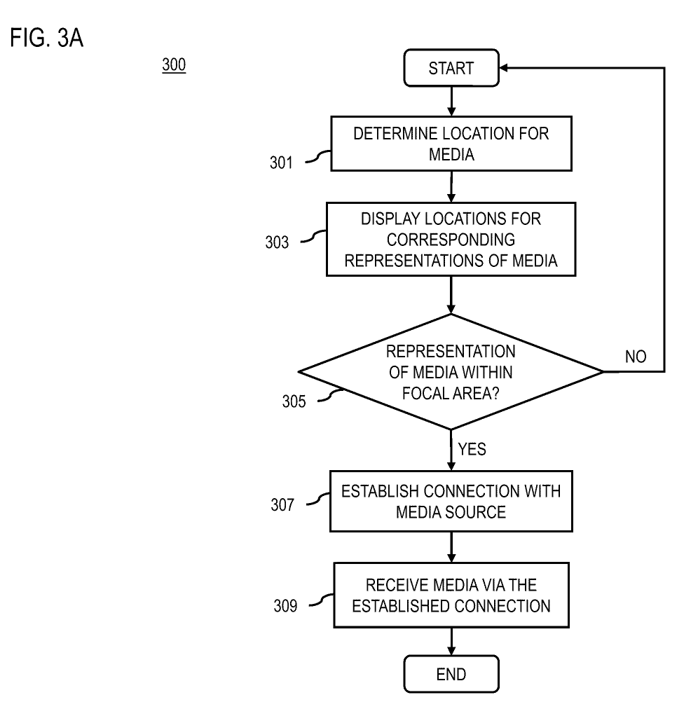

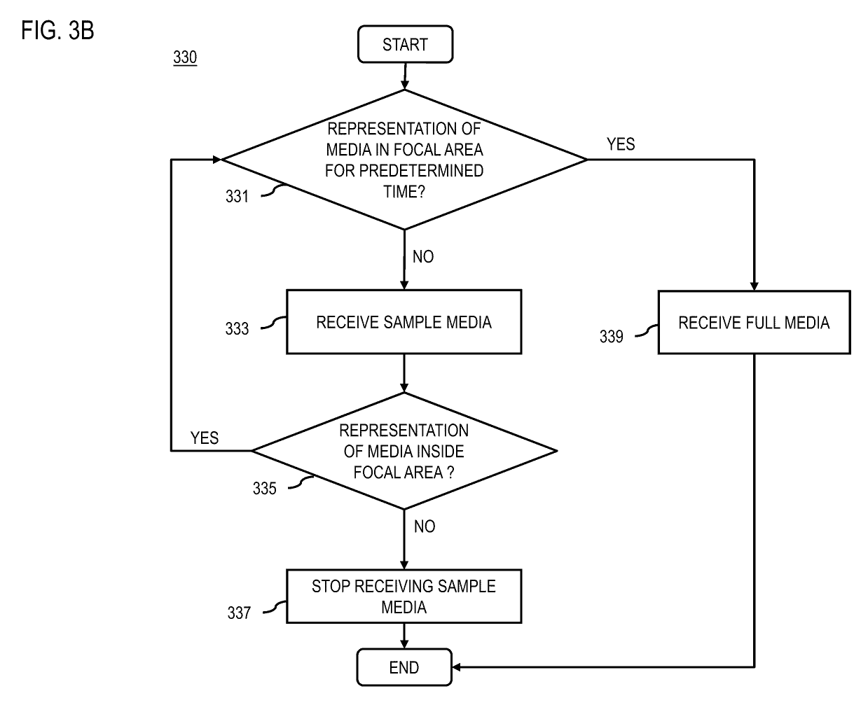

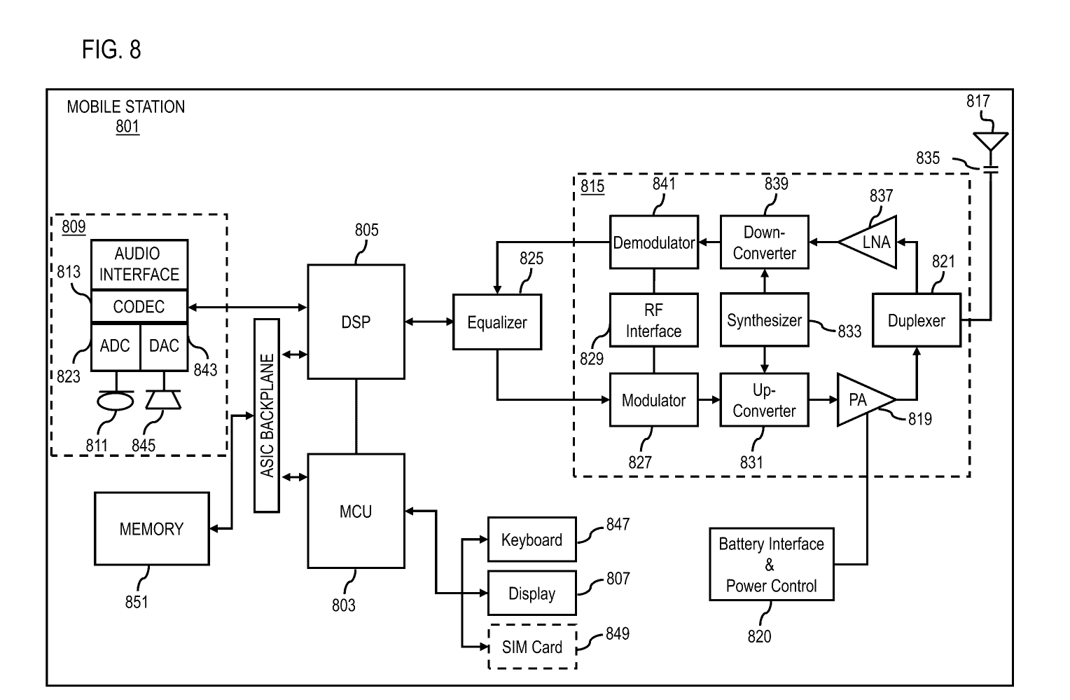

FIGS. 3A and 3B are flowcharts of a process for accessing media based on physical locations, according to one embodiment. FIG. 3A is a flowchart of an overall process for accessing media based on physical locations. In one embodiment, the media access platform 107 performs the process 300 and is implemented in, for instance, a chip set including a processor and a memory as shown FIG. 8. In step 301, the media access platform 107 receives location information for representations of the media content items such that the locations for the representations may be rendered on a user interface of the UE 101. The representations of the media content items may be shown as geometric figures, for example. Further, the representations of the media content items may be in different sizes, different shapes, different shades, and/or different colors to represent various parameters related to the media content items and the source providing the media content items. The parameters may include connection qualities, types of the sources of the media content items, the popularity of the source (e.g. service) providing the media content items, the types of the media content items (e.g. genre). The representations of the media content items may also be shown as graphical icons, wherein the graphical icons have shapes that describe these parameters. For example, a shape of the graphical icon for the UE 101 as the source may shape like a cellular phone, and a shape of the graphical icon for the Internet as the source may shape like a computer.

The location information may be determined differently depending on the source of the media content items. For example, if the source of the media content item is a wireless access point (such as a wireless hotspot or a media hotspot), the media access platform 107 detects the media content items at the wireless access point and determines the location of the media content items based on the location of the wireless access point. The physical location of the wireless access point may be determined by methods including a triangulation method using directional antennas or a detection method using a directional signal detector. Alternatively, the wireless access point may already have location information (e.g. a location ID) that can be downloaded to the UE 101 when the UE 101 detects or connects the wireless access point. The information that can be downloaded to the UE 101 from the wireless access point may also include an application ID of the wireless access point device, a content description ID, etc. This information may then be displayed on the UE 101 when the UE 101 shows a location of the wireless access point based on data from location sensors such as a GPS device, a compass, an accelerometer, or the like.

Another source of the media content items may be the Internet. The internet may further provide the location information such as coordinates, heights, etc. of the locations, wherein such location information is already stored in a database such as the service storage 111. In one embodiment, this location information of the media content items may be downloaded to the UE 101 via, for instance, the Internet or other network connection. Also, another source of media content items may be another UE 101. A peer-to-peer connection may be established between the UEs 101a-101n, wherein some of the UEs 101a-101n may be sharing the media content items or broadcasting the media content items. Then, the location of the UE 101 may be determined or estimated by a location positioning method such as global positioning system (GPS), cellular triangulation (e.g., Global System for Mobile communications (GSM) triangulation), and the like.

The UE 101 may also download a list of media hotspots and related data, either automatically or upon a user request. By way of example, the hotspot broadcast content may include a header or parameter specifying the related data which may include type of content, category, etc., and the hotspot location information (e.g. latitude and longitude information) for displaying the hotspots on the UE 101. The related data may also contain authentication information. In one embodiment, each hotspot can be registered for inclusion in the list of the hotspot broadcasting content, and the hotspots' related data are provided in the list. For example, hotspot providers or broadcasting entities may register their respective hotspots with a dedicated service via, for instance, a website. Further, the hotspot location information is used with the location positioning method in order to display the hotspot location in a corresponding area in the user interface of the UE 101. Thus, when accessing the media hotspots, the media access platform 107 determines what hotspots exist, and whether the hotspots can be accessed (e.g., depending on authentication information), and retrieves location information of the hotspots to display on the UE 101.

After the location information is determined, the locations are displayed for corresponding representations of the media content items in the user interface of the UE 101, as shown in step 303. In displaying the locations, the user interface may display an area corresponding to a geographical area. The user interface also includes one or more focal areas, and the representations of the media content items may be displayed based on the corresponding locations of the media content items. In one embodiment, the focal areas remain at static positions with respect to the user interface, while the representations of the surrounding geographical area and media content items move with the user interface depending a detected movement of the UE 101, input at the UE 101, or the like. The location information may be used to display the locations of the media content items on a map using a map application. In addition or alternatively, the location information may be shown in other applications that do not use maps or other graphics for representing the location. For example, the other applications may use a text, audio, haptic, etc. based interface for indicating the location of the media content. In addition, in another embodiment, the location need not be determined by the GPS or GSM-based location services to display the area surrounding the UE 101. Rather, without determining the location of the UE 101, the user may enter the address of the location the UE 101 is located. Then, the UE 101 may display an area surrounding the address entered by the UE 101, and the media hotspots are displayed on corresponding locations.

By way of example, the geographical area may represent a limited area or a predetermined area surrounding the UE 101. In one embodiment, the user interface may also enable zooming in and out of the displayed geographical area. If the locations of multiple representations are approximately the same, then these representations may be displayed next to each other, or the user interface may show an indication that there is more than one representation in the same location. Further, the geographical area displayed on the user interface may be a dynamic representation of a geographic area relative to the location of the UE 101 such that the geographic area displayed on the user interface is constantly updated based on the movement of the UE 101.

In one embodiment, the UE 101 may have a location sensor (e.g., a GPS sensor, gyroscope, etc.) to determine the location of the UE 101. The UE 101 may also have a compass to aid the determination of the location of the UE 101, and to provide the direction to which the user points the UE 101. In this way, the geographical area depicted in the user interface may be constantly updated based on the determined location and/or directional heading of the UE 101. Then, the UE 101 may be moved until at least one of the representations is in one or more of the focal areas of the user interface. For example, the UE 101 may be moved so that the direction of the UE 101 is pointed toward the geographical area having the representations, in order to place the representations within the focal area of the user interface. The representations may be selectively displayed on the user interface based on conditions and/or preferences specified, for instance, by the user, network operator, service provider, etc. The preferences may include the parameters discussed above, such as connection qualities, types of the sources of the media content items, the popularity of the source (e.g. service) providing the media content items, the types of the media content items. Thus, a user may choose not to display representations corresponding to the sources with bad connection qualities, for example. Further, as another example, the user may also choose not to display representations corresponding to the media content item that the user does not have access due to rights restrictions. Additionally, as another example, the user may select an option to display representations corresponding to the media content items that are recommended based on user's tendency in accessing the media content items.

The media access platform 107 determines whether the representations of the media content items are within the focal area, as shown in step 305. The focal area may be a predetermined area based on device capabilities (e.g., ability to connect to the source of the media content items). It is contemplated that the focal area may also be customizable by a user, in different sizes and shapes, and multiple focal areas may be designated by the user. In one embodiment, if the representations of the media content items are within the focal area, the media access platform 107 establishes connection with the source of the media content items within the focal area, as shown in step 307, and receives the media content items via the established connection, as shown in step 309. The media content item may include music, video, documents, pictures, etc. Further, advertisements or brochures including information about the media content item or any other information may also be streamed or downloaded in step 309.

This process advantageously enables a user of the UE 101 to match the locations surrounding the UE 101 with media content items available for access by the UE, thereby reducing the burden associated with discovering and accessing media content. Thus, the user may have enhanced experience in accessing media using the UE 101 whenever the user sees locations related to the media. The media access platform 107 is a means for achieving these advantages.

FIG. 3B shows a flowchart of a process for accessing the media content items, according to one embodiment. In one embodiment, the media access platform 107 performs the process 330 and is implemented in, for instance, a chip set including a processor and a memory as shown FIG. 8. The process 330 may occur during the process 300 of FIG. 3A to determine whether to access sample media or full media. In step 331, the media access platform 107 determines whether the representations of the media content items are in the focal area for a predetermined time period. The predetermined time period may be preset or be customized by a user. If the representations are in the focal area for a predetermined period of time, then full access to the media content items corresponding to the representations in the focal area are granted, as shown in step 339. Full access to the media content items enables, for instance, the UE 101 to stream the media content items or download the entire media content items. If the representations are in the focal area for a less than a predetermined period of time, samples of the media content items, information for retrieving the content, other messages, etc. are accessed, as shown in step 333. The UE 101 then accesses (e.g., streams, downloads, etc.) the limited content (e.g., media sample, content description, etc.). The media access platform 107 then determines whether the representations are in the focal area, as shown in step 335. If the representations are still within the focal area, step 331 is performed again to determine whether the representations have been in the focal area for the predetermined time. If the representations are no longer within the focal area, then the media access platform 107 stops receiving the sample media, as shown in step 337. If there are multiple representations of the media content items in the focal area, then one of the representations may be selected to access the source for the media content item corresponding to the selected representation. The selection can be performed by a user or automatically based on conditions such as connection qualities, type of the source, genre of the media content items, etc. Also, the media access platform 107 may simultaneously access multiple representations of the media content items. For example, if two representations of the media content items are within the focal area for the predetermined period of time, the media access platform 107 may download a media content item while streaming another media content item.

By providing for different actions based on length of time in the focal area, the media access platform 107 advantageously enables access to multiple functions using a common control mechanism (e.g., placing items in the focal area). The media access platform 107 is a means for achieving these advantages.

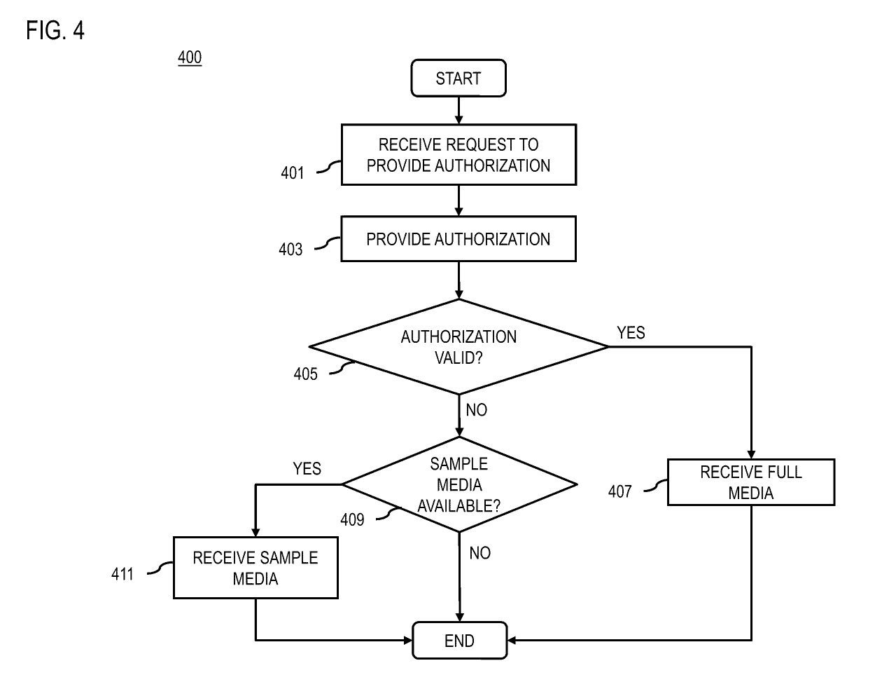

FIG. 4 is a flowchart of a process for authorizing access to media content items, according to one embodiment. In one embodiment, the media access platform 107 performs the process 400 and is implemented in, for instance, a chip set including a processor and a memory as shown FIG. 8. In step 401, when the media access platform 107 attempts to access the media content item after establishing a connection to the source of the media content item, the media access platform 107 may receive a request from the source to provide authorization. Then, the media access platform may provide authorization, as shown in step 403. The authorization may be in a form of a user id and a matching password. The authorization may also be in a form of user registration for the source of the media content item. Further, step 403 may provide a link to a website that allows the user to provide authorization via the website. The authorization may be stored in the UE 101 to be provided automatically, or may be manually input by the user. Then, the source of the media content item determines whether the authorization is valid, as shown in step 405. If the authorization is valid, full access to the media content item corresponding to the representation in the focal area is provided, as shown in step 407. If the authorization credentials are not valid, the media access platform 107 determines if there is a sample media available, as shown 409. If there is available sample media, then the sample media is received from the source, as shown in step 411.

This process advantageously ensures that only authorized users access the media content item via the mobile device, and also provides sample media to help the user determine whether to obtain authorization (e.g., purchase or subscribe to the content) in case where the authorization is not valid and the sample media is available. The media access platform 107 is a means for achieving these advantages.

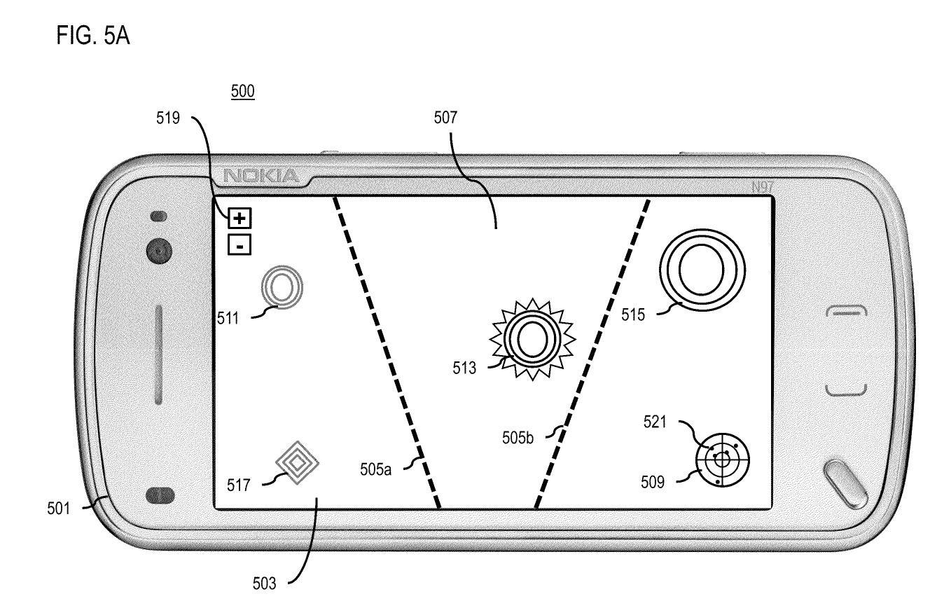

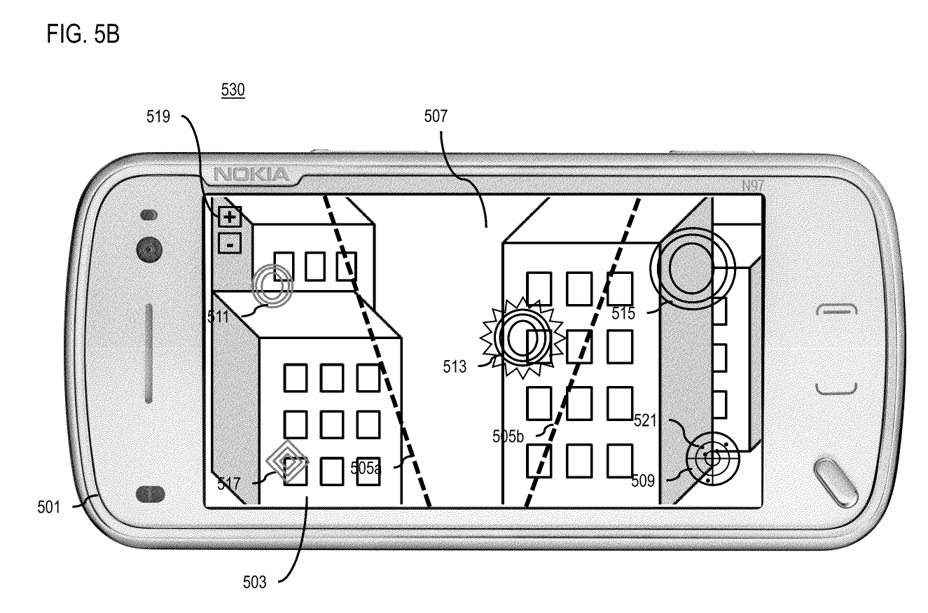

FIG. 5A is a diagram of user interfaces utilized in the processes of FIG. 3, according to one embodiment. The UE 101 may be a mobile device 501 with a display screen 503. The display screen may be a touch screen that is capable of detecting the location of a touch and use the touch as an input. On the display screen 503, focal lines 505a and 505b are displayed to define a focal area 507, which is the area between the two focal lines 505a and 505b on the display screen 503. The focal lines 505a and 505b may be customized and their locations may be changed, in order to customize the focal area 507, within the focusing capability of the mobile device 501. In one embodiment, the display screen 503 represents a particular geographical area as a media radar 509 that shows locations for the media content items with respect to the mobile device 501, wherein the center of the radar 509 represents a position of the mobile device 501 and the dots 521 represent locations for the media content items. For example, when the dots 521 representing the media content items appear on the radar, an alert or sound may be played to alert the user that there are media content items that can be accessed. The dots 521 may be displayed on the radar 509 based on the direction to which the UE 101 is faced, wherein the direction is estimated via a compass or any other location sensor. Because the dots 529 represent the media content items, the locations of the dots 521 on the radar 509 may help the user to steer the UE 101 until the media content items are shown on the display screen 503.

In this embodiment, only the top half of the media radar is rendered in the display screen 503. The circle icons 511, 513 and 515 represent media hotspots, and thus the circle icons 511, 513 and 515 show relative locations of the sources of the media content items. The diamond icon 517 represents a physical location related to the media content items. In one embodiment, the actual source of the media content items may not be in the physical location but in other locations such as the Internet. Accordingly, the respective location indicated in the display screen 503 represents a location associated with the content item rather than the actual source or location of the item. In this example, the icons 511, 513, 515 and 517 are rendered in different sizes to represent, for instance, the connection quality of the sources corresponding to the icons 511, 513, 515 and 517. More specifically, the connection quality is represented by the relative sizes of the icons, wherein larger icon sizes represent better connection quality. Further, the icons 513 and 515 are in a darker shade of color than the icons 511 and 517, which means the sources corresponding to the icons 513 and 515 are more popular than the sources corresponding to the icons 511 and 517. The popularity of the media sources may depend on one or more criteria, such as content of the media, customer base of the source, the number of active users subscribed and/or registered in the service, etc. The popularity may also depend on time and/or frequency (e.g. the number of downloads within last five days or within last two months). Further, when the mobile device 501 is steered such that the circle 513 is positioned within the focal area 507, the circle icon 513 starts blinking as an indication that a sample media related to the circle icon 513 is available for streaming or downloading. The circle icon 513 goes from blinking to being highlighted after the circle icon 513 is placed within the focal area 507 for a predetermined period of time. Then, full access to the media content item related to the circle icon 513 is available. Further, the geographical area displayed on the user interface may be zoomed in and out by selecting a plus (+) and a minus (−) options 519. The plus (+) and the minus (−) options 519 may be touch screen options that can be selected by touching the screen in corresponding areas.

FIG. 5B is a diagram of user interfaces utilized in the processes of FIG. 3, according to another embodiment. FIG. 5B is identical to FIG. 5A, except for the feature of including a picture of an area surrounding the UE 101 (e.g. the mobile device 501) in the display screen 503. As shown in FIG. 5B, either by utilizing a camera in the mobile device 501 or pictures stored in the mobile device 501 or the Internet, a view, a map or parts of the map (e.g., 3D figures from the map and/or restaurant data, gas station data, hotels data, etc.) or other representation of the area surrounding the mobile device 501 may be displayed as a background in the user interface. All or a portion of the map data can be shown transparently or semi-transparently on the screen. Further, when the location of a source is identified, the location and respective map data (e.g., restaurant or other point-of-interest data) are matched and the source and related data can be shown on the map. The view of the surrounding area corresponds with the geographical area represented in the user interface in the display screen 503. The view of the surrounding area may also be constantly updated as the mobile device 501 is moved (e.g. changes in the device's location, directional heading, and tilt angle), in order to display a picture of the surrounding area relative to the position of the mobile device 501 and provided, for instance, an augmented reality display. The changes in the device's location, directional heading and tilt angles may be detected by a GPS device, an accelerometer, a gyroscope, a compass, a camera sensor, any other type of location sensor, or any combination thereof. As shown, the icons 511, 513, 515 and 517 in the augmented reality display represent the media content items (or the media content type) available in the user interface depiction of the surrounding area. Accordingly, as the user moves the mobile device 501, the view in the augmented reality display and the displayed icons 511, 513, 515 and 517 changes dynamically based on the movement. Further, the map data shown on the screen as well as the locations of the displayed icons 511, 513, 515 and 517 may be constantly updated based on the detected movement of the UE 101, and thus the map and the displayed icons 511, 513, 515 and 517 may appear to move in correlation with the movement of the UE 101. As another embodiment, instead of a picture of the surrounding area, a graphical representation of the surrounding area (e.g. virtual reality) or a map (2D or 3D) of the surrounding area or a combination of a map and a picture of the surrounding area may be overlaid as a background in the display screen 503. This map and map related data may be downloaded to the device from a map service (e.g., the Ovi Maps service).

The processes described herein for selecting and accessing media based on physical locations having available media may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

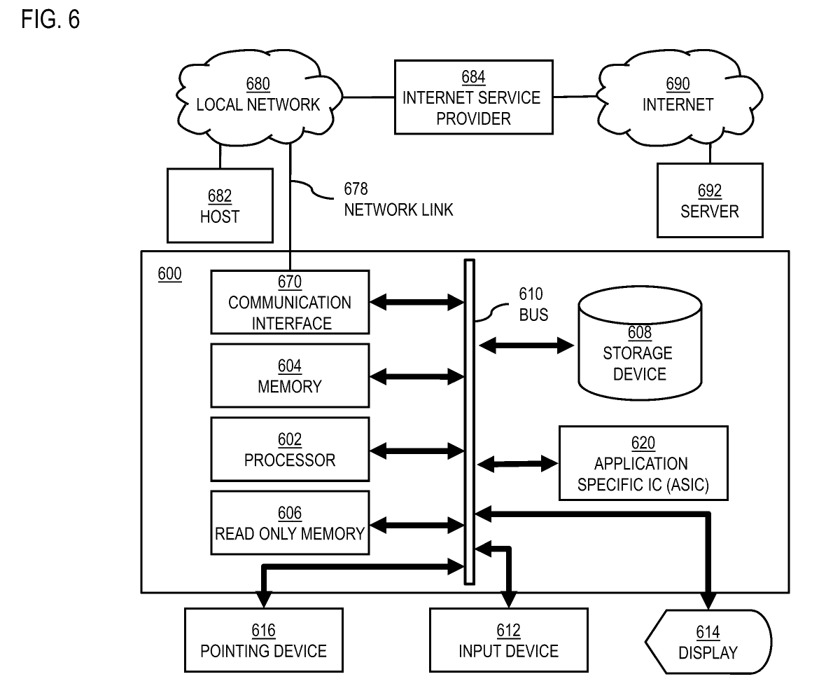

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to select and to access media based on physical locations having available media as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of selecting and accessing media based on physical locations having available media.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to selecting and accessing media based on physical locations having available media. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for selecting and accessing media based on physical locations having available media. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for selecting and accessing media based on physical locations having available media, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for selecting and accessing media based on physical locations having available media.

The term “computer-readable medium” as used herein to refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

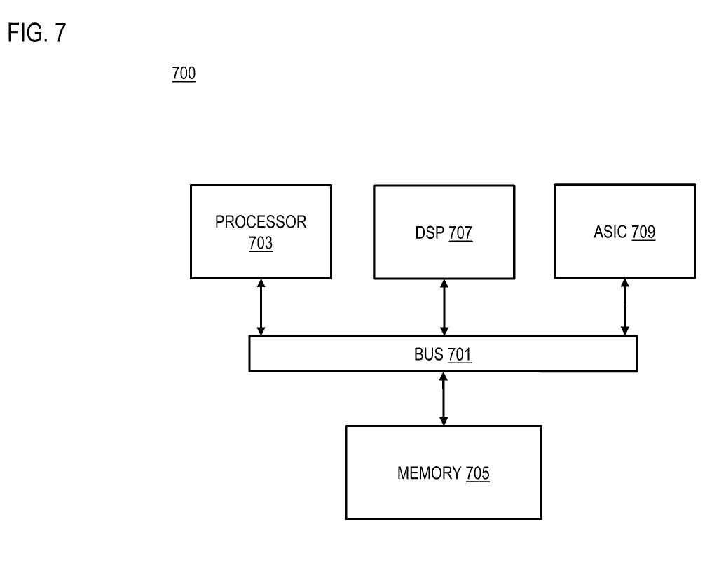

FIG. 7 illustrates a chip set 700 upon which an embodiment of the invention may be implemented. Chip set 700 is programmed to select and to access media based on physical locations having available media as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of selecting and accessing media based on physical locations having available media.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to select and access media based on physical locations having available media. The memory 705 also stores the data associated with or generated by the execution of the inventive steps.

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of selecting and accessing media based on physical locations having available media. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of selecting and accessing media based on physical locations having available media. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to select and access media based on physical locations having available media. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
causing, at least in part, rendering of a user interface, the user interface corresponding to a geographical area and including one or more focal areas;
determining media content available within the geographical area; and
causing, at least in part, rendering of one or more representations of the available media content in the user interface.

2. A method of claim 1, further comprising:
receiving input to bring one or more of the representations within at least one of the focal areas; and
causing, at least in part, access of one or more media content items corresponding to the one or more representations brought within the at least one focal area

3. A method of claim 2, further comprising:
determining an amount of time that the one or more of the representations remain within the at least one focal area; and
based on the determination, selecting whether to sample, download, or stream the corresponding one or more media content items.

4. A method of claim 1, further comprising:
detecting the media content items at a wireless access point;
determining location information of the media content items based, at least in part, on a location of the wireless access point,
wherein the rendering of the representations of the media content items is based, at least in part, on the location information.

5. A method of claim 1, further comprising:
querying a server for the media content items available within the geographical area; and
receiving location information associated with the media content items,
wherein the rendering of the representations of the media content items is based, at least in part, on the location information.

6. A method of claim 1, wherein the user interface is an augmented reality display, a virtual reality display, three-dimensional mapping display, two-dimensional mapping display, or a combination thereof.

7. A method of claim 2, wherein the input is detected as movement based, at least in part, on a location, directional heading, angle of elevation, or a combination thereof of a device.

8. A method of claim 2, further comprising:
receiving an authorization request to access the one or more media content items corresponding to the one or more representations brought within the at least one focal area.

9. An apparatus comprising:
at least one processor; and
at least one memory including computer program code,
the at least one memory and the computer program code configured to, with the at least one processor, cause the apparatus to perform at least the following,
cause, at least in part, rendering of a user interface, the user interface corresponding to a geographical area and including one or more focal areas;
determine media content available within the geographical area;
cause, at least in part, rendering of one or more representations of the available media content in the user interface.

10. An apparatus of claim 9, wherein the apparatus is further caused, at least in part, to:
receive input to bring one or more of the representations within at least one of the focal areas; and
cause, at least in part, access of one or more media content items corresponding to the one or more representations brought within the at least one focal area

11. An apparatus of claim 10, wherein the apparatus is further caused, at least in part, to:
determine an amount of time that the one or more of the representations remain within the at least one focal area; and
based on the determination, select whether to sample, download, or stream the corresponding one or more media content items.

12. An apparatus of claim 9, wherein the apparatus is further caused, at least in part, to:
detect the media content items at a wireless access point;
determine location information of the media content items based, at least in part, on a location of the wireless access point,
wherein the rendering of the representations of the media content items is based, at least in part, on the location information.

13. An apparatus of claim 9, wherein the apparatus is further caused, at least in part, to:
query a server for the media content items available within the geographical area; and
receive location information associated with the media content items,
wherein the rendering of the representations of the media content items is based, at least in part, on the location information.

14. An apparatus of claim 9, wherein the user interface is an augmented reality display, a virtual reality display, three-dimensional mapping display, two-dimensional mapping display, or a combination thereof

15. An apparatus of claim 10, wherein the input is detected as movement based, at least in part, on a location, directional heading, angle of elevation, or a combination thereof of the device.

16. An apparatus of claim 10, wherein the apparatus is further caused, at least in part, to:
receive an authorization request to access the one or more media content items corresponding to the one or more representations brought within the at least one focal area.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
causing, at least in part, rendering of a user interface, the user interface corresponding to a geographical area and including one or more focal areas;
determining media content available within the geographical area;
causing, at least in part, rendering of one or more representations of the available media content in the user interface.

19. A computer-readable storage medium of claim 18, wherein the apparatus is caused, at least in part, to further perform:
receiving input to bring one or more of the representations within at least one of the focal areas; and
causing, at least in part, access of one or more media content items corresponding to the one or more representations brought within the at least one focal area.

20. A computer-readable storage medium of claim 19, wherein the apparatus is caused, at least in part, to further perform:
determining an amount of time that the one or more of the representations remain within the at least one focal area; and
based on the determination, selecting whether to sample, download, or stream the corresponding one or more media content items.
